(19) United States
(12) Patent Application Publication
(10) Pub. No.: US 2017/0142468 A1
(43) Pub. Date: May 18, 2017

(54) ACCOUNT LINKING FOR INTEREST BASED ASSET DELIVERY

(71) Applicant: Canoe Ventures, LLC, Englewood, CO (US)

(72) Inventor: Jason Canney, Highlands Ranch, CO (US)

(21) Appl. No.: 14/943,614

(22) Filed: Nov. 17, 2015

(51) Int. Cl. H04N 21/262; H04N 21/61; H04N 21/258

(52) U.S. Cl. CPC H04N 21/26291; H04N 21/25891; H04N 21/25875; H04N 21/6125; H04N 21/6118; H04N 21/6143; H04N 21/26241

(57) ABSTRACT

Embodiments herein provide for linking internet-based user accounts to their equipment for improved targeted advertising. A link manager communicatively couples a user's internet account to UE being operated by the user, provides the user with a login to the user's internet account via the UE, and retrieves profile information from the user's internet account, including interests of the user. A campaign manager configures asset campaigns for insertion of assets into COD content. And, an ADS determines that a COD content has been selected by the UE, retrieves the asset campaigns from the campaign manager, analyzes the user's interests, identifies an asset of the campaigns to insert into the selected COD content based on the user's interests, qualifies/ranks the identified asset with other assets of the campaigns, and directs insertion of the identified asset in the COD content at a headend after the identified asset has been qualified and ranked.

### CROSS REFERENCE TO RELATED APPLICATIONS

This patent application is related to commonly owned and co-pending patent application Ser. Nos. 13/628,324, 13/628,360, and 13/628,381 (each having a filing date of Sep. 27, 2012), the entire contents of each of which are incorporated by reference.

### FIELD OF THE INVENTION

The invention relates to the field of Content On Demand (COD) systems and asset insertions into COD content selections.

### BACKGROUND

Television networks, such as the American Broadcasting Company (ABC), the Columbia Broadcasting Company (CBS), and the National Broadcasting Company (NBC), have for years broadcast television shows to the masses as a means for generating revenue through advertising. For example, these networks produce television shows and then seek out sponsors to advertise on the shows. The television shows, or “content”, have designated timeslots in which the sponsors' advertisements, or “assets”, are inserted. The content and the inserted assets are then broadcast by the television networks, or “content providers”, to the public over federally licensed communication airways, occasionally referred to as linear video distribution.

This “shotgun” approach to advertising proved to be very successful in the beginning However, as the number of advertisers wishing to sell their goods and services increased, television evolved into a much more complex system of communications. Today, cable television providers and satellite television providers serve as intermediary content providers between the content providers and the intended public audience. And, the number of content providers has increased accordingly. In this regard, many members of the general public have signed on as customers of the cable/satellite content providers so as to receive a broader availability of content.

Because the market for content consumption has grown, the number of content providers has also grown. And, because each of these providers has its own method of content delivery, the manner in which the content and assets are delivered to the customers has become increasingly complex. Generally, the content providers deliver the content to the content providers with instructions to insert various national assets into the content at certain times. For example, if a company wishes to run a national advertisement campaign targeting a certain television show associated with a particular demographic, the company may purchase one or more timeslots, or “placement opportunities”, within that television show from the content provider to air assets advertising the goods and services of the company. The content provider then provides the content to each of the content providers with directions to insert the assets within the timeslots purchased by the company.

The content providers may also have certain timeslots available for inserting certain local assets. For example, a content provider may have “headends” configured in various communities to distribute content to their customers located therein. Each headend receives content from the content providers with various designated timeslots for inserting assets into the content. Some of those timeslots may be designated for local advertisements where companies within the service area of the headend wish to advertise. These companies purchase those timeslots from the content provider for insertion of their assets to expose the customers to their advertising at the more local level.

As complex as the cable/satellite television has become, certain devices have come along to change and/or circumvent these forms of marketing altogether. The digital recorder, such as that produced by Tivo, is one example of a means for avoiding the asset insertions of marketing strategists. With the digital recorder, the content providers' customers are able to digitally record entire episodes of content and view that content at their leisure, as opposed to a time established by the content providers. However, these customers can also use the digital recorders to fast-forward or skip through the assets without viewing them, much to the dismay of the asset owners.

In response, content providers started providing content on a “Content On Demand” (COD) basis, sometimes referred to as nonlinear video distribution. In COD, the content provider delivers the content to the content provider which in turn maintains the content for subsequent and individual distribution to their customers. Thus, a customer may select a desired content through a set-top box (STB), a smart phone, computer, or the like (collectively referred to herein as “customer premise equipment” or “CPE”) and watch that content at the customer's leisure.

This COD content can also be configured with timeslots where assets may be inserted. For example, an advertiser desiring to place an advertisement in a particular TV show may pay the owner of that TV show (e.g., a content provider such as NBC, ABC, CBS, etc.) to insert their advertisements into one or more the timeslots in the COD content. Once inserted, the asset is delivered in the COD content to a user's CPE. However, assets that are inserted into the requested COD content are not always what the user is interested in.

### SUMMARY

Systems and methods presented herein provide for linking internet-based user accounts to their CPEs for improved targeted advertising. In one system, a link manager communicatively couples a user's internet account to a CPE being operated by the user, provides the user with a login to the user's internet account via the CPE, and retrieves profile information from the user's internet account, including interests of the user. A campaign manager configures asset campaigns for insertion of assets into COD content. And, an asset decision system (ADS) determines that a COD content has been selected by the CPE, retrieves the asset campaigns from the campaign manager, analyzes the user's interests, identifies an asset of the campaigns to insert into the selected COD content based on the user's interests, qualifies/ranks the identified asset with other assets of the campaigns, and directs insertion of the identified asset in the COD content after the identified asset has been qualified and ranked.

The various embodiments disclosed herein may be implemented in a variety of ways as a matter of design choice. For example, the embodiments may take the form of physical machines, computer hardware, software, firmware, or combinations thereof. In one embodiment, a computer readable medium is operable to store software instructions for directing the asset insertion into content. These software instructions are configured so as to direct a processor or some other processing system to operate in the manner described above. Other exemplary embodiments are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary system for linking an Internet-based user account to a CPE for improved targeted advertising.

FIG. 2 is a flowchart of an exemplary process operable with the system of FIG. 1.

FIG. 3 is a block diagram of a headend operation with an exemplary ADS.

FIG. 4 is an exemplary timing diagram of a COD content selection with timeslots available for asset insertion.

FIG. 5 is a block diagram of an exemplary ADS.

FIG. 6 is a block diagram of an exemplary processing system operable to link internet-based user accounts to their equipment for improved targeted advertising.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

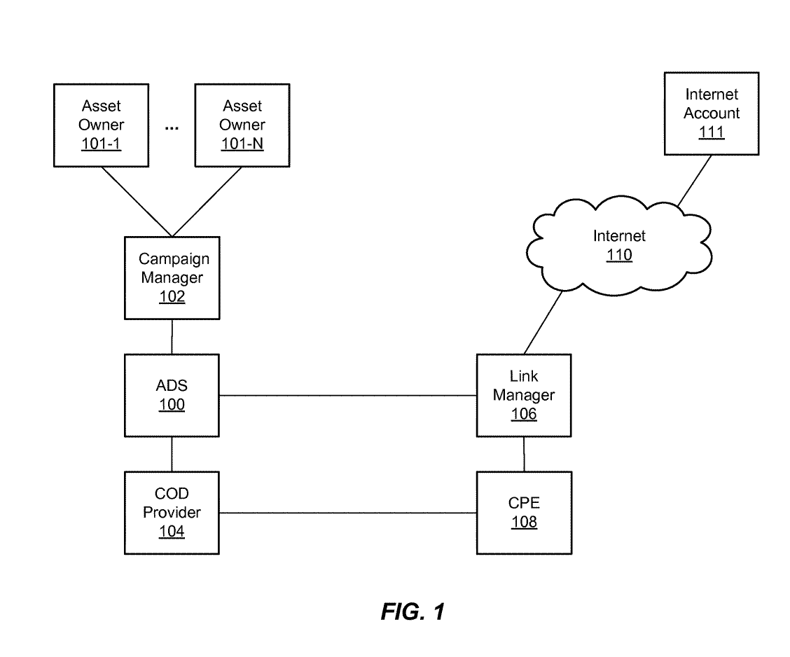

FIG. 1 is a block diagram of an exemplary system for linking an internet-based user account 111 to a CPE 108 for improved targeted advertising. As mentioned, COD content selections made by a user through the user's CPE 108 can have assets (e.g., advertisements) inserted therein by a COD provider 104, such as a cable television headend, satellite television operator, or even a content owner. An ADS 100 is operable to improve the asset insertions by removing conflicting assets and ranking remaining assets such that they provide more value to the content provider 104 and/or asset owners 101-1-101-N (wherein the reference “N” is merely intended to represent an integer greater than “1”). But, the delivered assets may not be all that interesting to the user selecting the COD content.

Generally, assets promoting products and services on television are maintained by asset owners 101. These asset owners 101 develop campaigns which are subsequently managed and maintained by the campaign manager 102. The asset campaigns comprise rules and asset descriptions (e.g., configured as a data structure) that an asset owner 101 may believe serves the asset owner 101's best marketing interests. For example, the Coca-Cola Company may have a number of advertisements it wishes to be inserted into COD content. Each of those advertisements may be associated with a campaign that targets various demographics of viewers (e.g., age, sex, ethnicity, location, etc.). Some of those assets may even cross multiple campaigns. And each asset campaign has rules that may, for example, prevent Pepsi-Cola Company advertisements from being inserted too close in time to Coca-Cola advertisements. The campaign manager 102 manages these asset campaigns and provides them to the ADS 100 such that the ADS 100 can select assets that provide value to the COD provider 104 while complying with the rules of the asset campaigns.

A link manager 106 is communicatively coupled to the ADS 100 and to the user's CPE 108 to provide insight as to what assets the user may find more interesting. In this regard, the link manager 106 links the user's internet account 111 to the user's CPE 108 such that the user can log into the user's internet account 111. Once logged in, the link manager 106 retrieves profile information from the user's internet account 111 including information pertaining to interests of the user. This information can be used to assist in asset insertion into the user's selected COD content.

The internet account 111 of the user can be of any type where the user has a profile established. Examples of internet account 111 include Facebook, Pinterest, LinkedIn, Instagram, and web email accounts. The link manager 106 may be implemented in a variety ways as a matter of design choice. For example, the link manager 106 may be a network server or some other computer that communicates through the Internet 110 to the internet account 111. Alternatively, the link manager 106 may be configured within the CPE 108 itself to provide log in capabilities through the CPE 108. For example, the CPE 108 may represent an end device that receives cable-television content from the COD provider 104. The CPE 108 may also be configured to link directly to the Internet to retrieve Internet content and present that content to the user through some display, such as a television. Similarly, the CPE 108 may link to the user's internet account 111 allowing the user to log into the account through the CPE.

The campaign manager 102 may also be implemented in a variety ways as a matter design choice. For example, the campaign manager 102 may include databases that store local and national advertisements for insertion to the COD provider 105 in addition to the various campaigns that are to be implemented in the COD content insertion. The ADS 100 is any device, system, software, or combination thereof operable to implement the rules of the campaigns and subsequently rank assets for insertion in the content provided by COD provider 104. The ADS 100 is generally configured as a system that is separate and distinct from the COD provider 104 such that the ADS 100 may interact with a plurality of COD providers. In some embodiments the campaign manager 102 and the ADS 100 are implemented together so as to provide a compact/centralized system for maintaining asset campaigns and directing insertion of the assets into the COD content while still being able to serve multiple COD providers.

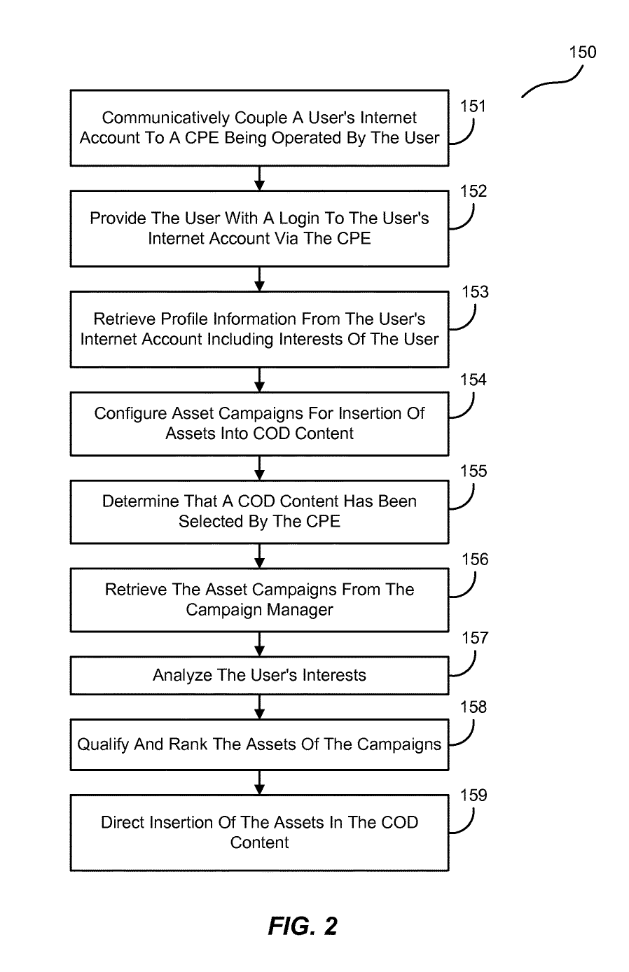

Additional details regarding the ADS 100 and the actual insertion of assets in the COD content are shown and described below. Now, one exemplary process of the ADS 100, the link manager 106, and the CPE 108 are shown and described in the flowchart of FIG. 2.

In FIG. 2, the process 150 provides for linking an internet-based user account 111 to a CPE 108 for improved targeted advertising. The process 150 initiates when the link manager 106 communicatively couples the user's account 111, in the process element 151. The link manager 106 provides a user of the CPE 108 with a login to the user's internet account through the CPE 108, in the process element 152. For example, the link manager 106 may communicate through the Internet 110 to link the CPE 108 to the user's internet account 111 through a login presented at the CPE 108. In a cable television industry embodiment, the link manager 106 may translate the Internet traffic into traffic presentable at the CPE 108. For example, the link manager 106 may translate Internet traffic into Data Over Cable Service Interface Specification (DOCSIS) messaging that is formatted by the CPE 108 to present a similar login interface to the user via the user's display device.

Once the user has logged in, the link manager 106 may retrieve profile information from the user's internet account 111, in the process element 153, and transfer interests of the user to the ADS 100 to assist the ADS in presenting more relevant assets to the user in selected COD content. For example, a user may have a Pinterest account established on the Internet. With Pinterest, users can upload, save, sort, and manage images (“pins”) and other media content through interest collections known as “pinboards”. From there, other users can browse the content in their respective “feeds”. Thus, users can personalize their experiences by pinning items, creating boards, and interacting with other members with each user's “pin feed” displaying unique, personalized results. And, the link manager 106 can access these personalized experiences of the users and present them to the ADS 100 to assist the ADS 100 in selecting assets that are more relevant to the users.

As mentioned, the campaign manager 102 manages the asset campaigns for the insertion of assets into selected COD content. The campaign manager 102 may also be operable to configure the asset campaigns, in the process element 154. For example, the asset owners 101 may deliver asset descriptions and rules associated with the assets to the campaign manager 102. The campaign manager 102 may in turn configure and maintain asset campaigns based on those asset descriptions and rules from the asset owners 101.

Once the interests of a particular user are retrieved by the link manager 106, the link manager 106 transfers the information to the ADS 100 for more relevant directed asset delivery. Then, when the user selects a COD content through the user's CPE 108, in the process element 155, the ADS 100 can retrieve asset campaigns from the campaign manager 102, in the process element 156, and analyze the user's interest, in the process element 157. Based on the user's interests, the ADS 100 can select certain assets from the asset campaigns that are more relevant to the user and then qualify and rank the assets of the campaigns according to the asset campaign rules, in the process element 158. For example, some assets even though they may be relevant to the user may be excluded from ranking because the rules of any given campaign may preclude the asset from being placed in the same COD content selection as another asset. In any case, once the ADS 100 performs the ranking on the assets, the ADS 100 directs the COD provider 104 to insert the assets into the selected COD content based on that ranking, in the process element 159.

In some embodiments, the campaign manager 102 may reconfigure existing asset campaigns once the interests of a particular user are retrieved. For example, the campaign manager 102 may determine that a certain asset campaign may have one or more assets that are relevant to the user while other assets of the campaign are less relevant or even completely irrelevant to the user. Accordingly, the campaign manager 108 may remove those assets from the campaign and deliver the new asset campaigns to the ADS 100 for directing insertion of assets into the selected COD content.

To provide a more illustrative example, assume an 18-year-old male user has selected a COD episode of “Two and a Half Men” through the CPE 108. That user may also have a Facebook account where the user shares his likes and interests with other users linked to him on Facebook. The link manager 106 may prompt the user to log into his Facebook account through the CPE 108. The link manager 106 may then retrieve his interests from his Facebook page and transfer that information to the ADS 100. The ADS 100 may in turn determine that the 18-year-old male user is very interested “Monster” brand energy drinks Based on the COD content selection of “Two and a Half Men”, a campaign may exist for the campaign manager 102 that corresponds to intended asset delivery of snack advertisements, although individual assets and/or asset campaigns may exist at the campaign manager 102 for energy drinks The ADS 100, in this regard, may identify assets for energy drinks in the campaign manager 102 based on the user's interest in Monster energy drinks and determine that the other energy drink assets may be more appealing to the 18-year-old male user. The ADS 100 may even identify Monster energy drinks that would be more useful to the 18-year-old male user when viewing the COD content selection of “Two and a Half Men”.

The ADS 100 may also remove certain assets from being delivered in the COD content selection based on the user's interests. For example, the 18-year-old male user may have little to no use for Lipitor advertisements that lower blood cholesterol. Accordingly, if an asset campaign comprises rules that are intended to deliver Lipitor ads during the selected COD content, the ADS 100 may identify other more relevant ads for delivery in the selected COD content and remove Lipitor ads from potential delivery.

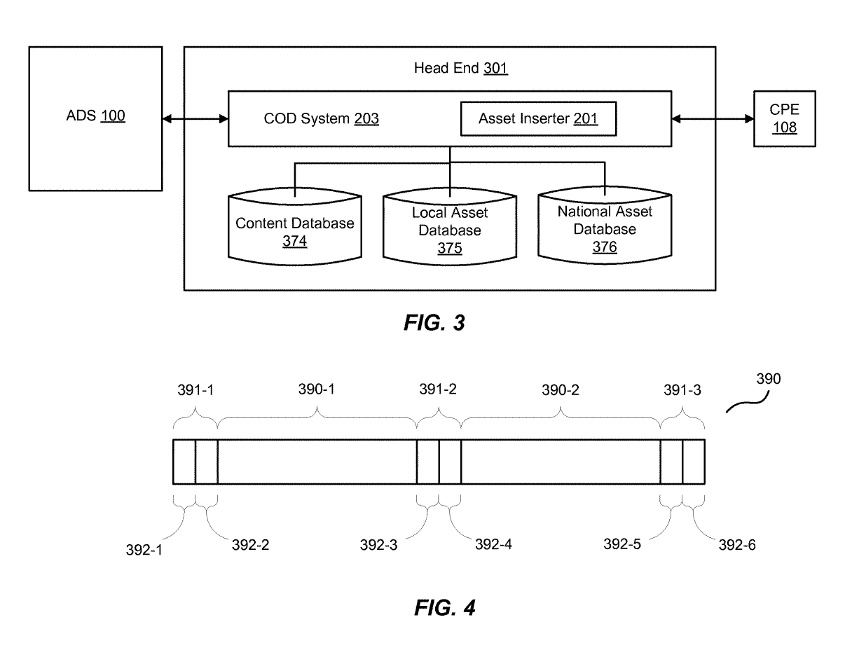

FIG. 3 is a block diagram of an exemplary ADS 100 operable with a COD system 203 (also known as a “COD back office system”) of a headend 301. The ADS 100 illustrates one example of how the ADS 111 may operate. The headend 301, in this embodiment, is generally any system operable to receive content for processing and distribution to a CPE 108 (e.g., over a cable television infrastructure or from satellite). For example, the headend 301 may receive content from content providers over television signals for distribution to the customers of a cable content provider via the CPE 108, such as a set-top box (STB), a gaming console, a smart phone, an electronic tablet, a computer, or the like.

The COD system 203 of the headend 301 provides the COD content to the CPE 108 when desired by the customer. For example, the headend 301 may receive the content from the content providers and maintain that content within a content database 374. The headend 301 may also maintain local assets in a local asset database 375 and national assets in a national asset database 376. When a particular COD content is selected by the user of the CPE 108, an asset inserter 201 of the COD system 203 accesses the content database 374 to retrieve the selected content and deliver that content to the CPE 108.

The COD system 203 is any system or device that is operable to deliver video content to the CPE 108 when directed by the CPE 108. The databases 374, 375, and 376 are any systems or devices operable to store and maintain data, audio, and/or video for subsequent distribution to the CPE 108. For example, the databases 374, 375, and 376 may be operable within a computer system that stores the video and audio (e.g., MPEG) content and assets such that they may be accessed by the COD system 203 and delivered to the CPE 108 when desired by the user of such.

To illustrate the insertion of assets into content, FIG. 4 shows an exemplary timing diagram of content 390 interlaced with asset timeslots 391, also known as “break positions”. When the COD system 203 receives a message from the CPE 108 for the content 390, the COD system 203 retrieves the content 390 from the content database 374. The content 390, in this embodiment, is divided into two segments 390-1 and 390-2 with timeslots 391 disposed at the front end of the content 390-1 (i.e., timeslot 391-1 at the pre roll position), in between the content segments 390-1 and 390-2 (i.e., timeslot 391-2 at the mid roll position), and at the end of the content segment 390-2 (i.e., timeslot 391-3 at the post roll position). Each timeslot 391 is divided into two asset placement timeslots 392 (i.e., asset placement opportunities), each of which is capable of accepting an asset that is typically, but not always, 30 seconds in duration. Thus, a placement opportunity is generally a subset of time of a particular timeslot 391. The ADS 100 directs the COD system 203 to insert the assets according to a particular ranking that provides value for the content provider (e.g., monetary value, enhanced relationships with asset providers, etc.). In this regard, the ADS 100 may direct the COD system 203 to select assets from the national asset database 376 and/or the local asset database 375 for insertion into the asset timeslots 392-1-392-6 based on the ranking provided by the ADS 100.

Also, the invention is not intended be limited to any particular number of content segments 390 or any particular number of asset timeslots. In fact, an asset timeslot 392 may be subdivided for insertion of multiple assets. For example, television commercials are typically 30 seconds in length. Occasionally, however, asset providers reduce the material of certain assets to reduce the overall duration of a particular asset (e.g., by removing material from a 30 second commercial to reduce it to a 15 second commercial). Accordingly, a 30 second asset timeslot 392 may be configured to accept insertions of two 15 second assets. For example, in FIG. 7, the content 390 may be configured with the mid roll timeslot 391-2 having two 30 second asset timeslots 392-3 and 392-4. The asset timeslot 392-3 can thus be further divided into two 15 second asset timeslots 392-3-1 and 392-3-2, allowing for the insertion of two 15 second assets into the asset timeslot 392-3. Still, the invention is not intended to be limited to any particular asset duration, asset timeslot 392 duration, or timeslot 391 duration as such may be configured to meet certain business and/or technical needs.

It should be noted that the decisions regarding the direction of asset insertions occur quite rapidly. For example, the ADS 100 may be operable to make asset insertion decisions for a plurality of headends 301. And, each headend 301 may be operable to provide COD content to a plurality of CPE 108 at any given time, possibly thousands or more. Thus, when a COD content selection is made by a particular CPE 108, the ADS 100 responds in substantially real time to ensure that the COD system 203 has ample time to retrieve and insert the assets while processing the content selected by the CPE 108.

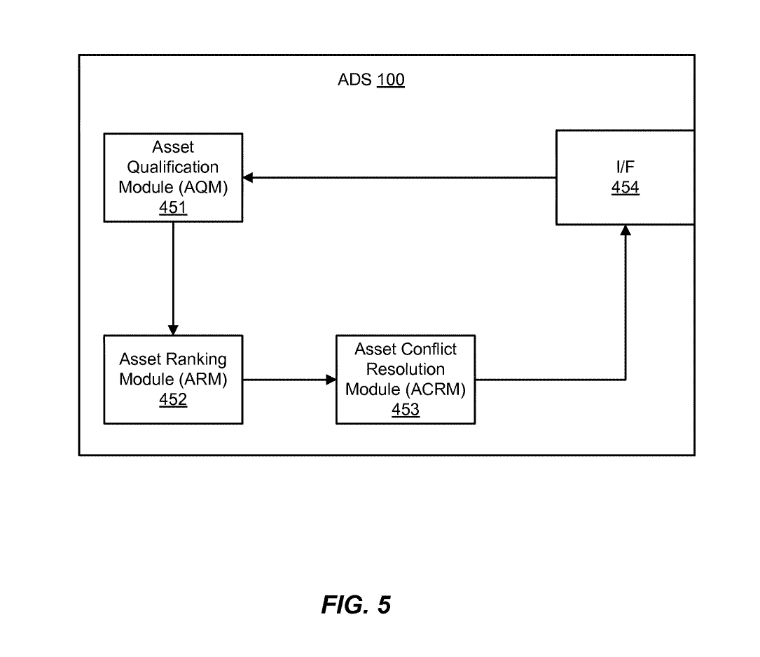

FIG. 5 is a block diagram of an exemplary ADS 100. In this embodiment, the ADS 100 includes an interface 454, an asset qualification module (AQM) 451, an asset ranking module (ARM) 452, and an asset conflict resolution module (ACRM) 453. The interface 454 is any device or system operable to receive information pertaining to a content selection by a CPE 108 such that the ADS 100 may direct asset insertion into the selected content. In this regard, the interface 454 may also be operable to transfer information to the COD system 203 to direct the COD system 203 to insert certain assets from the national asset database 376 and/or the local asset database 375.

The AQM 451 is any device or system operable to communicate with the interface 454 to initially qualify assets for insertion within the content. The AQM 451 may exclude certain assets from insertion into the content selected by the CPE 108. The ARM 452 is any device or system operable to rank the remaining assets (i.e., those not already excluded by the AQM 451) for insertion to the content 390. The ACRM 453 is any device or system operable to remove any ranked assets from insertion into the content 390 based on conflicts between assets. For example, the ACRM 453 may determine that assets from certain advertisers conflict with one another (e.g., Coke and Pepsi). Accordingly, the ACRM 453 may be operable to prevent assets from these advertisers from being inserted within a same timeslot 391 or even within a same content 390. The exemplary operations of the AQM 451, the ARM 452, and the ACRM 453 are explained in greater detail below.

The ADS 100 is any system, device, software, or combination thereof operable to interface with a plurality of asset providers to process information about assets (e.g., advertisements, marketing materials, etc.) of the asset providers such that the ADS 100 can direct a content provider to insert assets from the asset providers into COD content selected by a CPE 108. For example, the content provider may have access to content from a plurality of content providers (described in greater detail below) that the content provider provides to its customers via their respective CPE 108. In this regard, the content provider may include a COD system 203 that retrieves stored content for presentation to a CPE 108 when selected by a user of the CPE 108. The content provider may also have access to assets that are to be inserted into asset placement timeslots (i.e., asset placement opportunities) within the content. The ADS 100, being operable to provide value to the content providers, coordinates with campaigns of the asset providers to extract value for the content providers. In this regard, the ADS 100 may rank the assets of the asset providers in a manner that provides the most value to the content providers.

CPE 108 is any device or system capable of providing content to users. For example, a CPE 108 may be a set-top box operable to communicate with a cable television headend. Alternatively, a CPE 108 can be a computer or a mobile computing device capable of displaying video from a network (e.g., via streaming video over the Internet). For example, a CPE 108 may select a desired content from an Internet website hosted with an internet server (i.e., a content provider and COD system 203) through the network. Once selected, the COD system 203 may retrieve the content from a content database for Internet delivery to the selecting CPE 108. The ADS 100, being communicatively coupled to the COD system 203, processes information pertaining to the content selection and selects assets for insertion into that content from a national asset database and/or a local asset database, as illustrated in FIG. 3. To provide more context to the operations of the ADS 100, the following example is provided.

In this example, a CPE 108 selects a particular episode of the television show “30 Rock” at 8 pm on a Thursday night from a menu of COD content that is presented by the COD system 203. The COD system 203 retrieves that episode of 30 Rock from the content database 374. The COD system 203 then retrieves certain assets from the national asset database 376 for insertion into the timeslots of that show. As with many other 30 minute situational comedies, this episode of 30 Rock includes two content sections 390-1 and 390-2 and the three timeslots 391-1, 391-2, and 391-3, as illustrated in FIG. 4. Using this example, the COD system 203 transfers an asset insertion request to the AQM 451 to insert assets into these three timeslots. The AQM 451 then determines that there are a total of six 30 second asset placement opportunities within three timeslots 391-1-3 of the selected content 390. The AQM 451 then processes the active campaigns (e.g., data structures) to determine their eligibility within those six 30 second asset placement opportunities. Among the active campaigns in this example are:
1. A Coca-Cola campaign with a total of four assets and 3 campaign items directing placement opportunities of those assets as follows:
a) Asset 1 for 100 views anytime;
b) Asset 2 for any viewing opportunities Monday through Friday between the hours of 5 pm and 10 pm; and
c) Assets 3 and 4 for any viewing opportunities Friday and Saturday between the hours of 5 pm and 10 pm.
2. A Pepsi-Cola campaign with a total of five assets and four campaign items directing placement opportunities of those assets as follows:
a) Asset 1 for 20 views anytime;
b) Asset 2 for 100 views anytime;
c) Asset 3 for 1000 views anytime;
d) Asset 4 for any viewing opportunities Monday through Friday between the hours of 5 pm and 10 pm; and
e) Asset 5 for any viewing opportunities Friday and Saturday between the hours of 5 pm and 10 pm.
3. A Capital One credit card campaign with a total of four assets and three campaign items directing placement opportunities of those assets as follows:
a) Asset 1 for 100 views anytime;
b) Asset 2 for 1000 views anytime; and
c) Assets 3 and 4 for any viewing opportunities Monday through Friday between the hours of 5 pm and 10 pm.
4. A Chrysler Motors campaign with a total of three assets and two campaign items directing placement opportunities of those assets as follows:
a) Asset 1 for 100 views; and
b) Assets 2 and 3 for any viewing opportunities Monday through Friday between the hours of 5 pm and 10 pm.
5. A Nickelodeon campaign with one asset and one campaign item directing placement opportunities of that asset as follows:
a) Asset 1 for 100 views.

Since the television show 30 Rock has a mature theme and since the Nickelodeon campaign is directed towards a younger audience, that campaign item is automatically excluded from the eligible campaign list by the AQM 451. Other remaining campaign items are excluded based on time and date (i.e., campaign items 1c and 2e).

Thus the remaining campaigns of 1a-1b, 2a-2d, 3a-c, 4a-4b are transferred to the ARM 452 for ranking Based on various factors explained in greater detail below, the ARM 452 ranks the campaigns as follows:
1. Campaign Item 2a
2. Campaign Item 1a
3. Campaign Item 3c
4. Campaign Item 2b
5. Campaign Item 4b
6. Campaign Item 4a
7. Campaign Item 1b
8. Campaign Item 1d
9. Campaign Item 2c
10. Campaign Item 1c
11. Campaign Item 2d
12. Campaign Item 3a
13. Campaign Item 3b

The ARM 452 transfers this ranked list of campaign items to the ACRM 453 to determine conflicts within the ranked list of campaign items. Typically, the six available asset placement opportunities 392-1-6 within the content 390 would be filled by the first six campaign items based on a rank determined by the ARM 452. However, since some conflicts may exist between campaigns within a particular content and/or timeslot, certain campaigns may be excluded from the placement opportunities 392 such that the ranking is reordered. For example, certain criteria may dictate that a Pepsi Cola asset may not be placed within the same content as a Coca-Cola asset. In this regard, the campaign items 1a-1d are removed from the ranked list because the Pepsi-Cola asset has the higher initial ranking, leaving the following campaign items:
1. Campaign Item 2a
2. Campaign Item 3c
3. Campaign Item 2b
4. Campaign Item 4b
5. Campaign Item 4a
6. Campaign Item 2c
7. Campaign Item 2d
8. Campaign Item 3a
9. Campaign Item 3b

With this computed, the ACRM 453 may remove the final three campaign items 7, 8, and 9 from the list as the six placement opportunities can be filled with assets. The ACRM 453 then transfers this information regarding asset placement to the COD system 203.

Once all of the campaign items at each campaign have been evaluated and no campaigns remain or once all of the placement opportunities have been filled, the ACRM 453 directs the COD system 203 to retrieve the assets based on the list generated. For example, the list may be included in a report message that is transferred to the COD system 203 to direct the COD system 203 to insert the assets into the content selected by the CPE 108. It is possible that all of the assets have been excluded during the processes described herein. Thus, the ACRM 453 may then direct the COD system 203 to not place any assets in the content selected by the CPE 457.

The ACRM 453 may even direct the COD system 203 to place assets from the local database 375 and/or the national database 376 into the selected COD content as desired. The ACRM 453 may also direct the COD system 203 to place assets relating to content, programming, or even services provided by the content provider. For example, if no assets remain, standard programming information, such as time and date, pertaining to the selected COD content may be configured as an asset and placed in the selected COD content. To further illustrate, when an episode of “Modern Family” is selected by a CPE 108 and no assets remain for insertion into the available time slots of that episode, the ACRM 453 may direct the COD system 203 to present the user of the CPE 108 with the date and time when the next episode of Modern Family can be seen.

Since it is also possible that not all of the assets in the list may be placed as there may be more assets than available opportunities, the ACRM 453 may weight the assets prior to placement in the selected COD content. For example, certain assets may provide greater value to the content provider (e.g., the television network). In this regard, the ACRM 453 may rank the remaining assets in a manner that provides the most monetary compensation to the content provider. Thus, the ACRM 453 may reduce the list of available assets for insertion to the amount of opportunities, or timeslots, in the selected COD content to provide this value to the content provider. In any case, the ACRM 453 directs the COD system 203 to place the assets in the selected COD content based on the ranked list. Once placement has been directed, the ACRM 453 generates a placement report and transfers that report to the headend 301 so that the headend 301 can track marketing views (e.g., for later negotiations between content providers and marketers). For example, when a marketer can know how many views of a particular asset there were in a selected COD content, the marketer can assign a value to that asset that may be used in negotiating price for additional views of the asset in future selected COD content.

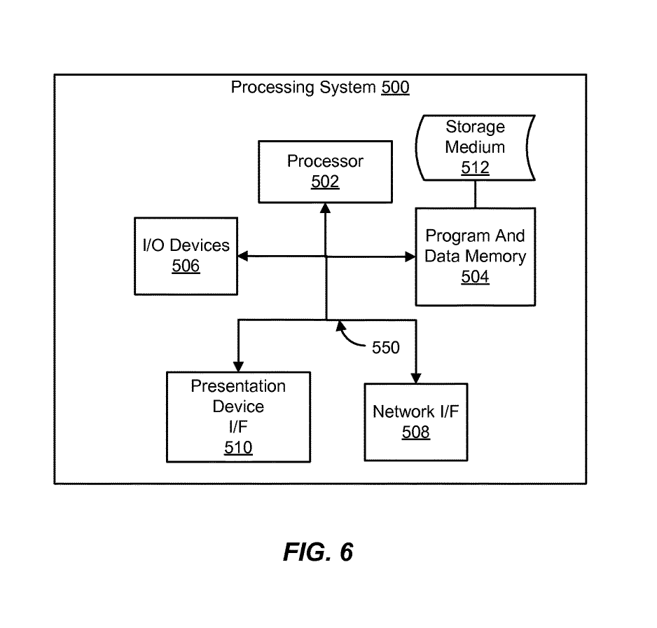

FIG. 6 is a block diagram depicting a processing system 500 also operable to provide the above features by executing programmed instructions and accessing data stored on a computer readable storage medium 512. In this regard, embodiments of the invention can take the form of a computer program accessible via the computer-readable medium 512 providing program code for use by a computer or any other instruction execution system. For the purposes of this description, computer readable storage medium 512 can be anything that can contain, store, communicate, or transport the program for use by a computer.

The computer readable storage medium 512 can be an electronic, magnetic, optical, electromagnetic, infrared, or semiconductor device. Examples of computer readable storage medium 512 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 500, being suitable for storing and/or executing the program code, includes at least one processor 502 coupled to memory elements 504 through a system bus 550. Memory elements 504 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 506 (including but not limited to keyboards, displays, pointing devices, etc.) can be coupled to the processing system 500 either directly or through intervening I/O controllers. Network adapter interfaces 508 may also be coupled to the system to enable the processing system 500 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 510 may be coupled to the system to interface to one or more presentation devices, such as printing systems and displays for presentation of presentation data generated by the processor 502.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only the preferred embodiment and variants thereof have been shown and described and that all changes and modifications that come within the spirit of the invention are desired to be protected.

Additionally, although the term “headend” generally suggests the distribution center or office of a cable television operator or MSO, the term is not intended to be so limited. The term headend as used herein is any system operable to deliver content to a viewer (e.g., a customer or user of the CPE). For example, the term headend may encompass satellite content providers that offer COD content and/or Internet services to its subscribers. That content is typically delivered directly to the subscriber's antenna for demodulation and decryption by the subscriber's CPE 108. Internet traffic in such a system may be conveyed by satellite and/or other delivery mechanisms (e.g., digital subscriber lines, or “DSL”, delivered through subscriber phone lines).

A headend may also refer to a telecom provider that distributes content to mobile phones and other devices. Also, the term “asset”, as used herein, includes any type of media for which an owner desires promotion. Examples of such include traditional television commercials, advertisements, streaming video commercials, promotional materials, marketing information, and the like. The term “content”, as used herein, is any type of media, such as audio and/or video, in which assets may be inserted. For example, the content operable within the COD delivery systems described herein may be streamed Internet audio/video, analog cable television feeds, digital cable television feeds, digital satellite television feeds, or digital satellite radio feeds. Thus, the content of the COD described herein is intended to encompass Video on Demand (VOD) and pay-per-view (PPV) delivered by both modern cable television and satellite television.

1. A system, comprising:
a link manager operable to communicatively couple a user's internet account to a customer premise equipment (CPE) being operated by the user, to provide the user with a login to the user's internet account via the CPE, and to retrieve profile information from the user's internet account, wherein the profile information includes interests of the user;
a campaign manager operable to configure asset campaigns for insertion of assets into Content on Demand (COD) content; and
an asset decision system (ADS) communicatively coupled to the campaign manager and to the link manager, wherein the ADS is operable to determine that a COD content has been selected by the CPE, to retrieve the asset campaigns from the campaign manager, to analyze the user's interests, to identify at least one asset of the campaigns to insert into the selected COD content based on the user's interests, to qualify and to rank the identified asset with other assets of the campaigns, and to direct insertion of the identified asset in the COD content at a headend after the identified asset has been qualified and ranked.

2. The system of claim 1, wherein:
the internet account is a social media account.

3. The system of claim 1, wherein:
the headend is a cable television provider.

4. The system of claim 1, wherein:
the headend is a satellite television provider.

5. The system of claim 1, wherein:
the headend is a streaming video provider.

6. A method, comprising:
communicatively coupling a user's internet account to a customer premise equipment (CPE) being operated by the user;
providing the user with a login to the user's internet account via the CPE;
retrieving profile information from the user's internet account, wherein the profile information includes interests of the user;
configuring asset campaigns for insertion of assets into Content on Demand (COD) content;
determining that a COD content has been selected by the CPE;
retrieving the asset campaigns from the campaign manager;
analyzing the user's interests;
identifying at least one asset of the campaigns to insert into the selected COD content based on the user's interests;
qualifying and ranking the identified asset with other assets of the campaigns; and
directing insertion of the identified asset in the COD content at a headend after the identified asset has been qualified and ranked.

7. The method of claim 6, wherein:
the internet account is a social media account.

8. A non-transitory computer readable medium comprising instructions that, when executed by one or more processors in a Content on Demand (COD) environment, direct the processors to:
communicatively couple a user's internet account to a customer premise equipment (CPE) being operated by the user;
provide the user with a login to the user's internet account via the CPE;
retrieve profile information from the user's internet account, wherein the profile information includes interests of the user;
configure asset campaigns for insertion of assets into COD content;
determine that a COD content has been selected by the CPE;
retrieve the asset campaigns from the campaign manager;
analyze the user's interests;
identify at least one asset of the campaigns to insert into the selected COD content based on the user's interests;
qualify and ranking the identified asset with other assets of the campaigns; and
direct insertion of the identified asset in the COD content at a headend after the identified asset has been qualified and ranked.

9. The computer readable medium of claim 8, wherein:
the internet account is a social media account.

10. The method of claim 6, wherein:
the headend is a cable television provider.

11. The method of claim 6, wherein:
the headend is a satellite television provider.

12. The method of claim 6, wherein:
the headend is a streaming video provider.

13. The computer readable medium of claim 8, wherein:
the headend is a cable television provider.

14. The computer readable medium of claim 8, wherein:
the headend is a satellite television provider.

15. The computer readable medium of claim 8, wherein:
the headend is a streaming video provider.
